(19) United States
(12) Patent Application Publication
(10) Pub. No.: US 2007/0290037 A1
(43) Pub. Date: Dec. 20, 2007

(54) Method, Computer Program Product And Portable Electronic Device For Providing Pricing Information To Assist A User In Comparative Shopping

(76) Inventors: Paul T. Arellanes, Austin, TX (US); Frank L. Jania, Chapel Hill, NC (US)

Correspondence Address: HARRINGTON & SMITH, PC, 4 RESEARCH DRIVE, SHELTON, CT, 06484-6212, US

(21) Appl. No.: 11/424,049

(22) Filed: Jun. 14, 2006

(51) Int. Cl. G06K 15/00; G07F 7/00

(52) U.S. Cl. 235/383; 705/27

(57) ABSTRACT

A computer program product including program instructions embodied on a tangible computer-readable medium is provided. Execution of the program instructions results in operations including: using a portable electronic device, obtaining location information, wherein the location information includes the current location of the portable electronic device; utilizing the obtained location information to specify at least one merchant; and displaying on the portable electronic device at least one item to be purchased at the specified at least one merchant.

### TECHNICAL FIELD

The teachings in accordance with the exemplary embodiments of this invention relate generally to a method, computer program product and portable electronic device for assisting users in shopping and, more specifically, relate to comparative shopping.

### BACKGROUND

Online shopping has become more prevalent in recent times, enabling shoppers to browse and purchase various items using computer systems, often from their own home. Users may purchase almost anything online, from cars to clothing to groceries. Online shoppers readily have access to product and store information. Even so, online shopping has not surpassed the volume of shopping done at physical locations.

Online services currently exist to assist shoppers in comparing prices among different merchants. One example of such a conventional service is Pricewatch. A shopper can go to the Pricewatch website on the Internet, look up specific electronic equipment or computer parts and compare prices for the item as available among different merchants. Such conventional services are disadvantageous for a number of reasons, not least of which is a user being limited to the particular items the service makes available for comparison, a user being limited to the particular merchants the service makes available for comparison and the inability of such services to provide geographically-relevant information (e.g. comparisons for local merchants) as might be useful when shopping at physical stores.

### SUMMARY

In an exemplary aspect of the invention, a computer program product is provided. The computer program product includes program instructions embodied on a tangible computer-readable medium. Execution of the program instructions results in operations including: using a portable electronic device, obtaining location information, wherein the location information includes the current location of the portable electronic device; utilizing the obtained location information to specify at least one merchant; and displaying on the portable electronic device at least one item to be purchased at the specified at least one merchant.

In another exemplary aspect of the invention, a method is provided. The method includes the steps of: using a portable electronic device, obtaining location information, wherein the location information includes the current location of the portable electronic device; utilizing the obtained location information to specify at least one merchant; and displaying on the portable electronic device at least one item to be purchased at the specified at least one merchant.

In a further exemplary aspect of the invention, a portable electronic device is provided. The portable electronic device includes: at least one memory; at least one data processor coupled to the at least one memory; at least one display device coupled to the at least one data processor; and a location determination unit coupled to the at least one data processor. The at least one data processor is operable to perform operations including: obtaining location information using the location determination unit, wherein the obtained location information includes the current location of the portable electronic device; utilizing the obtained location information to specify at least one merchant; and displaying on the at least one display device at least one item to be purchased at the specified at least one merchant.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a portable electronic device 1 incorporating aspects of the invention;

FIG. 2 shows another exemplary embodiment of a portable electronic device incorporating aspects of the invention;

FIG. 3 shows another exemplary embodiment of a portable electronic device incorporating aspects of the invention;

FIG. 4 illustrates another exemplary embodiment of a portable electronic device incorporating aspects of the invention;

FIG. 5 depicts another exemplary embodiment of a portable electronic device incorporating aspects of the invention;

FIG. 6 illustrates another exemplary embodiment of a portable electronic device incorporating aspects of the invention;

FIG. 7 shows another exemplary embodiment of a portable electronic device incorporating aspects of the invention;

FIG. 8 illustrates another exemplary embodiment of a portable electronic device incorporating aspects of the invention;

FIG. 9 depicts another exemplary embodiment of a portable electronic device incorporating aspects of the invention;

FIG. 10 shows another exemplary embodiment of a portable electronic device incorporating aspects of the invention;

FIG. 11 illustrates another exemplary embodiment of a portable electronic device incorporating aspects of the invention;

FIG. 12 depicts another exemplary embodiment of a portable electronic device incorporating aspects of the invention;

FIG. 13 shows a flowchart illustrating one non-limiting example of a method for practicing the exemplary embodiments of this invention;

FIG. 14 depicts a flowchart illustrating another non-limiting example of a method for practicing the exemplary embodiments of this invention;

FIG. 15 illustrates a simplified block diagram of a portable electronic device that is suitable for use in practicing the exemplary embodiments of this invention;

FIG. 16 depicts a simplified block diagram of one non-limiting example of a communications system within which the portable electronic device of FIG. 15 may operate;

FIG. 17 shows a flowchart illustrating another non-limiting example of a method for practicing the exemplary embodiments of this invention;

FIG. 18 depicts a flowchart illustrating another non-limiting example of a method for practicing the exemplary embodiments of this invention;

FIG. 19 illustrates a simplified block diagram of another portable electronic device that is suitable for use in practicing the exemplary embodiments of this invention; and

FIG. 20 depicts a simplified block diagram of another non-limiting example of a communications system within which the portable electronic device of FIG. 19 may operate.

### DETAILED DESCRIPTION

Online shopping provides a shopper with a number of features that are frequently unavailable at physical locations. One such feature is the ability to compare product prices as among different merchants (e.g. stores). An online shopper can easily obtain pricing information for the same or similar products as available from a number of different merchants. The online shopper can then use the pricing information to compare prices and determine which merchant has the best price.

Comparative shopping at physical stores is generally more difficult. A shopper usually would need to undertake substantial planning in advance of going to the physical store because comparison information is normally unavailable at such stores. Such planning would likely include researching prices, perhaps by utilizing weekly newspaper flyers or even the Internet, as non-limiting examples. Even so, a weekly newspaper flyer may be unavailable or pricing information may not be readily obtainable over the Internet. Furthermore, an amount of time and effort must be expended on such advance planning. In addition, while at the physical store it may be very difficult, if not impossible, for a shopper to compare prices for new products because most physical stores do not make competitors' prices available. Thus, it would be advantageous to provide techniques that enable a shopper to easily compare product prices even while at a physical store location.

As used herein, a portable electronic device is any hand-held electronic device capable of operating in accordance with the exemplary embodiments of the invention.

As used herein, a list, shopping list or dynamic shopping list refers to a collection of information comprising identification information for at least one item. The list may comprise identification information for a plurality of items. The list may further comprise additional information such as store identification information, pricing information and location information, as non-limiting examples.

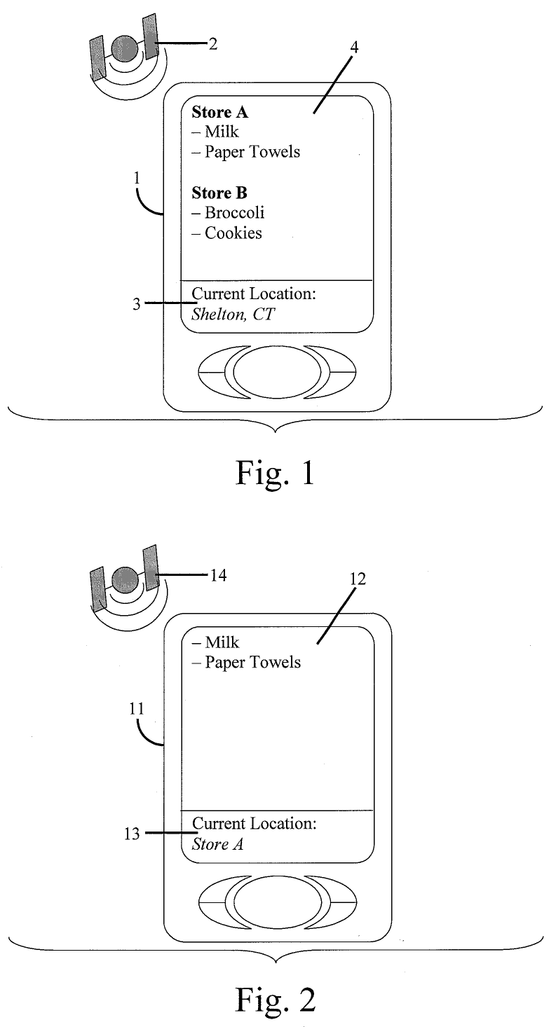

Referring to FIG. 1, a portable electronic device 1 is shown that incorporates aspects of the invention. The device 1 obtains location information that specifies the current location of the device 1. The device 1 uses the location information to select at least one merchant. The device 1 then displays at least one item to be purchased at the at least one merchant.

In the exemplary embodiment of FIG. 1, the device 1 is utilizing a global positioning system (GPS) 2 to determine the location information, that the device 1 is currently located in Shelton, Conn. The device 1 is showing its current location in a current location section 3 on a display screen 4 of the device 1. As the device 1 has determined it is currently located in Shelton, Conn., the device 1 has specified two local merchants: Store A and Store B, as shown on the display screen 4. A user has identified four items the user wishes to purchase: milk, paper towels, broccoli and cookies. On the display screen 4, the device 1 indicates at which merchant, Store A or Store B, the user should purchase each item. The device 1 matches the items with a recommended merchant according to a rule set.

The location information may be obtained by a user providing the current location (e.g. selecting a location from a list, entering a location, entering location information such as a U.S. zip code), by the device 1 using GPS or by the device 1 using any other suitable system that assists the device 1 in determining its current location, as non-limiting examples. In the exemplary embodiment of FIG. 1, the device 1 utilizes GPS 2 to determine that it is currently located in Shelton, Conn., as shown in the current location section 3 on the display screen 4. In other embodiments, the current location of the device 1 as shown on the device 1 may include a different identifier. As a non-limiting example, the current location may be identified by a store in which the device 1 is currently located. As an additional non-limiting example, the current location may be identified by different geographical information. In other embodiments, the device 1 may indicate the current location of the device 1 in other manners, such as highlighting the store name as shown in the shopping list, as a non-limiting example. In other embodiments, the device 1 may not show the current location of the device 1.

In the exemplary embodiment of FIG. 1, the device 1 specified two local merchants. In other embodiments, the device 1 may specify the at least one merchant according to different guidelines. As a non-limiting example, the at least one merchant may be specified according to a set of predefined user preferences (e.g. preferred merchants, merchants within a certain radius, merchants within a certain town). As a further non-limiting example, the device 1 may specify the at least one merchant according to item availability. Such embodiments may employed in conjunction with additional user preferences (e.g. lowest price, lowest priced product per type, brand loyalty) as further discussed below. In other embodiments, the device 1 may enable a user to select one or more merchants of the specified at least one merchant.

The information shown on the display screen 4 of the device 1 includes identification information for at least one item. The identification information identifies the item on the list and may be a generic or categorical label (e.g. “Paper Towels”) or a specific brand of the item (e.g. “Brand E” or “Brand E Paper Towels”), as non-limiting examples. In other embodiments, the information shown on the display screen 4 may comprise store identification information, pricing information or location information, as non-limiting examples.

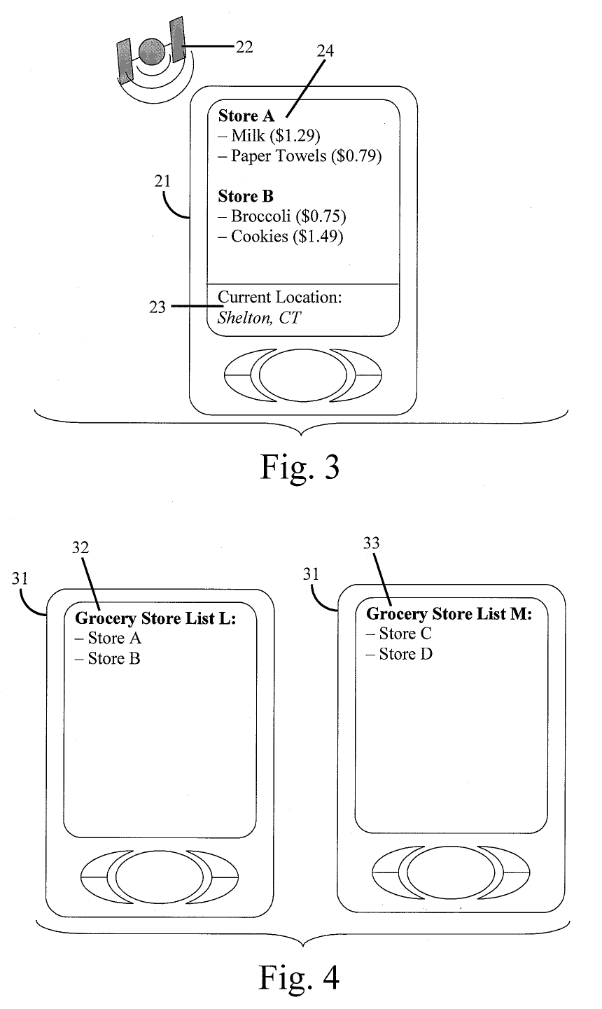

As noted above, the device 1 matches the items with a recommended merchant according to a rule set. In other embodiments, the rule set may be user-defined or provided by the device 1, as non-limiting examples. In other embodiments, the rule set may utilize item pricing information, as further discussed below with respect to FIG. 3. In further embodiments, the rule set may utilize other user preferences (e.g. lowest price, lowest priced product per type, brand loyalty) as further discussed below.

Referring to FIG. 2, another exemplary embodiment of a portable electronic device 11 is shown that incorporates aspects of the invention. The device 11 utilizes GPS 12 to determine that the device 11 is currently located in Store A, as shown in a current location section 13 on the display screen 14 of the device 11. The device 11 of FIG. 2 is using the same list of items and merchants as the device 1 of FIG. 1 (e.g. milk and paper towels at Store A; broccoli and cookies at Store B). However, in the exemplary embodiment of FIG. 2, because the device 11 has determined its current location to be Store A, the device 11 is only showing those items (milk and paper towels) that the user is to purchase in Store A.

Referring to FIG. 3, another exemplary embodiment of a portable electronic device 21 is shown that incorporates aspects of the invention. The device 21 utilizes GPS 22 to determine that the device 21 is currently located in Shelton, Conn., as shown in a current location section 23 on the display screen 24 of the device 21. The device 21 of FIG. 3 is using the same list of items and merchants as the device 1 of FIG. 1 (e.g. milk and paper towels at Store A; broccoli and cookies at Store B). However, in the exemplary embodiment of FIG. 3, the device 21 has obtained item pricing information to utilize when identifying the item to be purchased at the specified merchant. The item pricing information comprises the price of the item at a plurality of merchants. By utilizing the item pricing information, the device 21 can consider the price of the item at different merchants when matching the item to a specified merchant. As non-limiting examples, the device 21 can: match the item to a merchant who has the lowest price for that item, match the item to a merchant who has the lowest priced product per type for that type of item (e.g. lowest priced paper towels, lowest priced milk, lowest priced cookies), match the item to a merchant who has the lowest brand price for that brand of item (e.g. lowest price for Brand E paper towels) or match the item to a merchant based on the item being a priority type of item (e.g. an item the user is likely to purchase wherever the user goes shopping, regardless of a lower price elsewhere). In other embodiments, a user is provided with various options relating to the device 21 utilizing the item pricing information. As a non-limiting example, a user may select the criteria (e.g. lowest price, lowest price product per type, lowest brand price) the device 21 employs in matching items to a specified merchant.

In other embodiments, the device can obtain the item pricing information from an external source. Non-limiting examples of an external source include a computer system, a server and a database. The device 21 could connect to the external source through a communication interface, as a non-limiting example. The communication interface enables the device 21 to communicate, via a wired or wireless connection, with a foreign agent (e.g. an external source) for the purpose of updating, maintaining, uploading or downloading item pricing information. The communication interface may comprise any hardware necessary for the device 21 to establish, maintain and/or utilize a wired or wireless connection, such as technology relating to wireless local area networks (WLAN), Bluetooth technology, Wi-Fi technology, radio frequency (RF) communications, optical communications, cellular technology, universal serial bus (USB) connections or FireWire connections, as non-limiting examples.

In other embodiments, the item pricing information may be stored locally on the device. In further embodiments, such storage enables a user to recall the item pricing information at a later time. In other embodiments, a user may upload stored product pricing information to a database for storage and use on other electronic devices, such as a home computer, an online service or any other suitable computing device, as non-limiting examples. In further embodiments, the item pricing information is obtained by the device after specifying at least one merchant. In further embodiments, the product pricing information is obtained by the device prior to device obtaining location information. As a non-limiting example, item pricing information may be downloaded to the device and stored locally in advance of anticipated shopping or purchasing.

In the exemplary embodiment of FIG. 3, prices are shown for the items to be purchased. In other embodiments, the prices may not be shown for the items to be purchased. In further embodiments, the item pricing information may be shown on the device 21.

Referring to FIG. 4, another exemplary embodiment of a portable electronic device 31 incorporating aspects of the invention is shown. In FIG. 4, the device 31 is displaying a store list. The store list identifies the merchants for whom information is shown in the shopping list. Two store lists are shown in FIG. 4, Grocery Store List L 32 (Store A and Store B) and Grocery Store List M 33 (Store C and Store D). A user may create and store multiple store lists on the device 31. The store lists may be associated with or differentiated by categories (e.g. local grocery stores, local clothing stores) or locations (e.g. by towns or cities), as non-limiting examples. In other embodiments, a user may create and edit the name of the store list. In further embodiments, the device assists the user in creating a store list by recommending local merchants to include on the list. In other embodiments, the device makes such recommendations based on factors such as the type of merchant (e.g. grocery store, clothing store) and/or the geographical proximity of a merchant, as non-limiting examples.

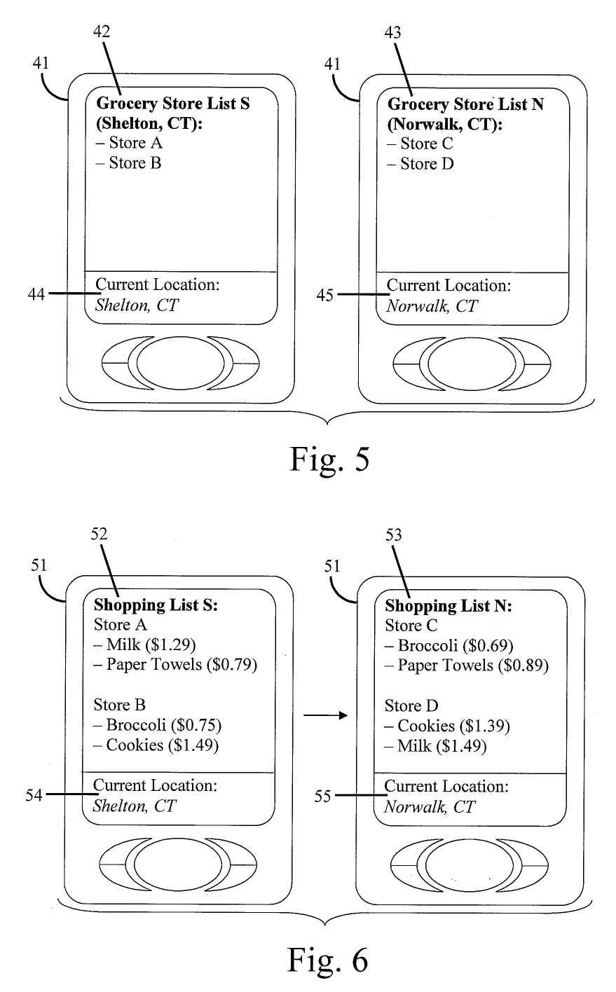

Referring to FIG. 5, another exemplary embodiment of a portable electronic device 41 incorporating aspects of the invention is shown. As shown in FIG. 5, the device 41 is displaying two store lists, Grocery Store List S (Shelton, Conn.) 42 (Store A and Store B) and Grocery Store List N Norwalk, Conn.) 43 (Store C and Store D). The store lists are associated with geographical locations. Grocery Store List S 42 is associated with Shelton, Conn. while Grocery Store List N 43 is associated with Norwalk, Conn. In such a manner, the device 41 can recommend a store list based on the current location of the device. As shown in the current location section 44, 45, when the device 41 determines it is currently located in Shelton, Conn. it will suggest that a user use Grocery Store List S 42, the grocery store list associated with Shelton, Conn., when shopping for groceries. However, when the device 41 determines it is currently located in Norwalk, Conn., as shown in the current location section 45, it will suggest that a user use Grocery Store List N 43 when shopping for groceries. Thus, in this exemplary embodiment local or nearby merchants may be recommended and/or used in the shopping list based on the current location of the device 41.

Referring to FIG. 6, another exemplary embodiment of a portable electronic device 51 incorporating aspects of the invention is shown. As shown in FIG. 6, the device 51 is displaying two shopping lists, Shopping List S 52 (Store A and Store B) and Shopping List N 53 (Store C and Store D). The device 51 is showing its current location in a current location section 54, 55. When the device 51 has determined it is currently located in Shelton, Conn., as apparent by the current location section 54 display, the device 51 specifies two local merchants: Store A and Store B. A user has identified four items the user wishes to purchase: milk, paper towels, broccoli and cookies. The device 51 indicates at which merchant, Store A or Store B, the user should purchase each item. The device 51 matches the items with a recommended merchant according to a rule set, as discussed above.

Should the location of the device 51 change, the specified merchants may change. In such an occurrence, the displayed shopping list, as relating to matching items with a recommended merchant according to the rule set, would be updated to reflect the change in the specified merchants.

In the exemplary embodiment of FIG. 6, a user has transported the device from Shelton, Conn. to Norwalk, Conn. In so doing, the shopping list 52 shown on the device 51 has updated to reflect the change in location. When the device 51 has determined it is now located in Norwalk, Conn., as apparent by the current location section 55 display, the device 51 specifies two different local merchants: Store C and Store D. The device 51 indicates at which merchant, Store C or Store D, the user should purchase each item on the shopping list 53. Although the shopping lists 52, 53 may be related to the current location of the device 51, the device 51 specifies merchants based on the current location of the device.

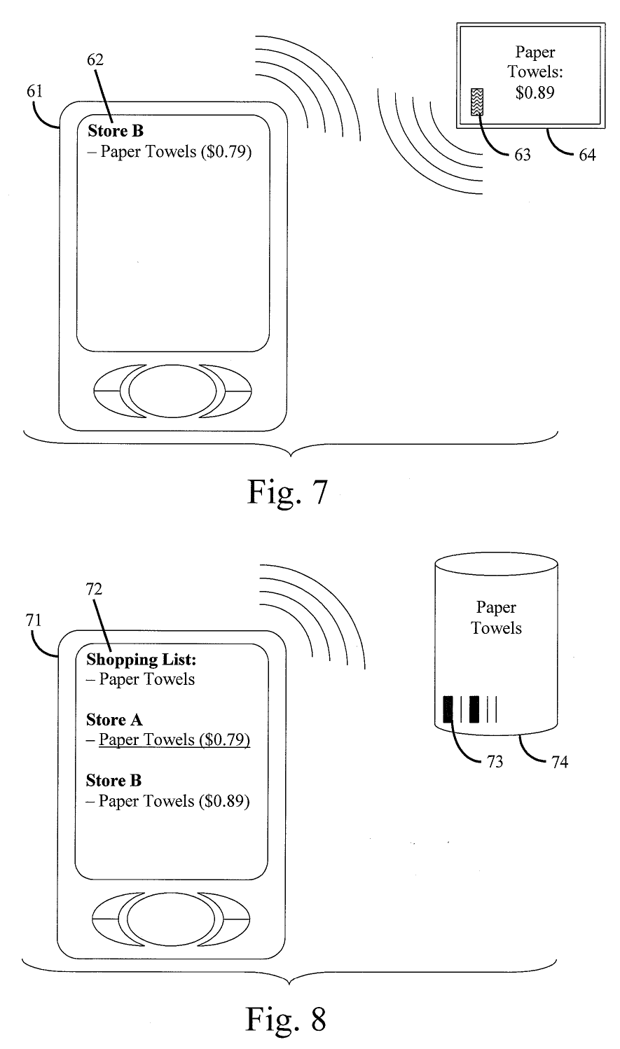

Referring to FIG. 7, a portable electronic device 61 is shown that incorporates aspects of the invention. The device 61 assists a user in comparing the prices of items as among multiple merchants. The device 61 has a display 62 on which it can show information to a user. The device 61 receives product identification information for an item located at a first merchant. The device 61 utilizes the received product identification information to obtain product pricing information. The product pricing information comprises a price for the item at at least one other merchant (e.g. at least one merchant other than the first merchant). The device 61 then displays the obtained product pricing information on the display 62.

The receipt of the product identification information by the device 61 can be accomplished by the device 61 receiving electromagnetic radiation, optical radiation and/or reflected electromagnetic radiation, as non-limiting examples. The received electromagnetic radiation may comprise a radio frequency transmission, as a non-limiting example. As a further example of a radio frequency transmission, the received product identification information may be transmitted to the device 61 by means of a radio frequency identification (RFID) tag. The received radiation may comprise infrared radiation, as a non-limiting example. The reflected electromagnetic radiation may include radiation such as reflected light from a bulb or laser source, as a non-limiting example. As a non-limiting example of the use of reflected electromagnetic radiation, the device 61 may utilize a scanner to read information from a universal product code (UPC) label. UPC labels come in a number of formats including UPC-A, UPC-E, EAN-13 and EAN-8, as non-limiting examples. As an additional non-limiting example of the use of reflected electromagnetic radiation, the device 61 may utilize optical character recognition (OCR) to receive product identification information.

The product identification information received by the device 61 may come from an item (e.g. a product), a product display, a product label or product signage, as non-limiting examples. As a non-limiting example, an RFID tag with product identification information could be incorporated into product advertising or signage such that a user could utilize the device 61 in accordance with the RFID tag to obtain product pricing information.

In FIG. 7, a user in Store A is utilizing the device 61 in accordance with an RFID tag 63 located on a sign for paper towels 64. The sign 64 indicates that the paper towels in Store A cost $0.89. The device 61 receives transmitted product identification information from the RFID tag 63. Utilizing the received product identification information, the device 61 obtains product pricing information for the product for at least one other merchant. In FIG. 7, the product pricing information is the price of paper towels at Store B. After obtaining the product pricing, the device 61 indicates on the display 62 that Store B is selling paper towels for $0.79. In FIG. 7, the first merchant is Store A and the at least one other merchant is Store B.

In other embodiments, the product pricing information may be stored locally on the device. Such storage enables a user to recall the product pricing information at a later time. In further embodiments, a user may upload stored product pricing information to a database for storage and use on other electronic devices, such as a home computer, an online service or any other suitable computing device, as non-limiting examples. In other embodiments, the product pricing information is obtained by the device after the product identification information has been received. In further embodiments, the product pricing information is obtained by the device prior to the reception of the product identification information. As a non-limiting example, product pricing information may be downloaded to the device and stored locally prior to the reception of product identification information (e.g. prior to receiving transmitted product identification information from an RFID tag, prior to scanning a UPC label).

In other embodiments, a user can manually change or modify the received product identification information prior to the device obtaining product pricing information. As a non-limiting example, a user could scan the UPC label on a 20-ounce bottle of glass cleaner. Before the device obtains product pricing information for the 20-ounce bottle of glass cleaner, the user could manually modify the product identification information such that the device instead obtains product pricing information for a 40-ounce bottle of glass cleaner.

Inasmuch as items may be added to the shopping list on the display 62 of the device 61 by the device 61 receiving product identification information, in other embodiments items may be removed from the shopping list by the device 61 receiving product identification information. As a non-limiting example, a user may delete an item on the shopping list by scanning the UPC label on the item. In such a manner, a user may indicate, in the shopping list, that the user has obtained the item in question. Thus, the shopping list would then show the remaining items that the user has yet to obtain.

Referring to FIG. 8, a portable electronic device 71 is shown that incorporates aspects of the invention. The device 71 displays a dynamic shopping list 72 to assist a user in comparing product prices among a plurality of merchants. The shopping list 72 displays product pricing information for at least one item (e.g. product). In the exemplary embodiment of FIG. 8, the shopping list 72 shows that Store A has paper towels for $0.79 while Store B has paper towels for $0.89. The device 71 indicates that Store A has the lowest price for paper towels by underlining the Store A paper towel entry in the shopping list 72. The underlined entry indicates the lowest priced product per type (e.g. the lowest priced paper towels). Also in the exemplary embodiment of FIG. 8, the shopping list 72 shows a product identifier. The product identifier identifies the item on the list and may be a generic or categorical label (e.g. “Paper Towels”) or a specific brand of the item (e.g. “Brand E” or “Brand E Paper Towels”), as non-limiting examples.

A user adds items to the shopping list 72 using the device 71. In FIG. 8, a user has added “Paper Towels” to the shopping list 72 by scanning a UPC label 73 on a roll of Paper Towels 74.

In FIG. 8, the user is using the device while in Store A (the first merchant). The shopping list 72 of FIG. 8 shows price information for Store A paper towels in addition to the product pricing information (e.g. the price of Store B paper towels). In other embodiments, such as the exemplary embodiment of FIG. 7, the device may not display price information for the product of the first merchant.

Although indicated in FIG. 8 and elsewhere below by underlining, in other embodiments the device may indicate the lowest priced product per type (e.g. lowest priced paper towels, lowest priced milk) by other means, such as highlighting the entry, bolding the entry or italicizing the entry, as non-limiting examples. In further embodiments, the device may not indicate the lowest priced product per type. In other embodiments, the device may indicate the lowest priced product per type for only one type at a time (e.g. only for paper towels). In further embodiments, the device may indicate the lowest priced product per type for only one type at a time based on user input, user selection or current user actions (e.g. only for paper towels because the user selected paper towels, only for paper towels because the user just added paper towels to the shopping list), as non-limiting examples. In other embodiments, if more than one merchant has the lowest priced product per type, the device may indicate such an occurrence to the user. In further embodiments, if more than one merchant has the lowest priced product per type, the device may not indicate the lowest priced product per type for that type of product. In other embodiments, if more than one merchant has the lowest priced product per type, the device may not indicate the lowest priced product per type only if the user is currently at a merchant who has the lowest priced product per type.

In other embodiments, a user may select the merchants for whom product pricing information is shown. In further embodiments, a user may select the merchants for whom product pricing information is shown as from a provided list of merchants for whom product pricing information is available.

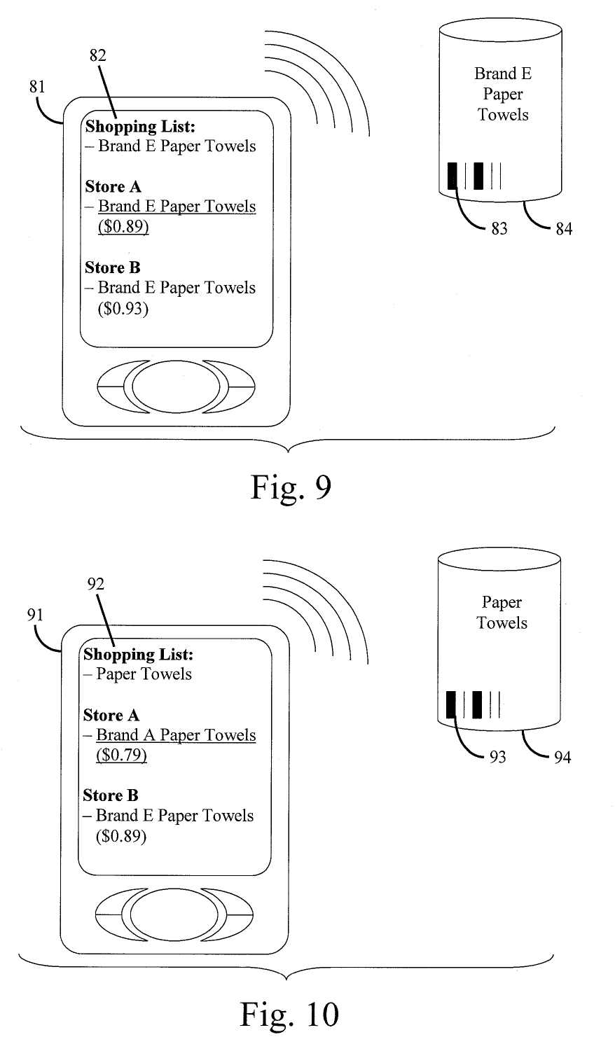

Referring to FIG. 9, another exemplary embodiment of a portable electronic device 81 incorporating aspects of the invention is shown. The device 81 displays a dynamic shopping list 82 to assist a user in comparing product prices among a plurality of merchants. In FIG. 9, the user has enabled the brand loyalty preference. The brand loyalty preference, when enabled, specifies that the user only wants to see product price information for that brand of product. For example, in FIG. 9 the user is only interested in seeing product price information for Brand E Paper Towels. The user does not wish to see product price information for other brands of paper towels. After enabling this preference, the user has added “Brand E Paper Towels” to the shopping list 82 by scanning a UPC label 83 on a roll of Brand E Paper Towels 84. The shopping list 82 only displays product price information for Brand E Paper Towels and indicates, by underlining the entry, that Store A has the lowest price for Brand E Paper Towels. In such a manner, if a user is loyal to a specific brand of a product, the user may view product price information only for that specific brand. The brand loyalty preference may be enabled on an item-by-item basis or on a global basis, as non-limiting examples.

Referring to FIG. 10, another exemplary embodiment of a portable electronic device 91 incorporating aspects of the invention is shown. The device 91 displays a dynamic shopping list 92 to assist a user in comparing product prices among a plurality of merchants. In FIG. 10, the user has not enabled the brand loyalty preference. The user has added “Paper Towels” to the shopping list 92 by scanning a UPC label 93 on a roll of Paper Towels 94. The shopping list 92 shows that Store A has Brand A Paper Towels for $0.79 while Store B has Brand E Paper Towels for $0.89. The Store A Paper Towels entry on the shopping list 92 is underlined to indicate that it is the lowest priced item of that type (paper towels).

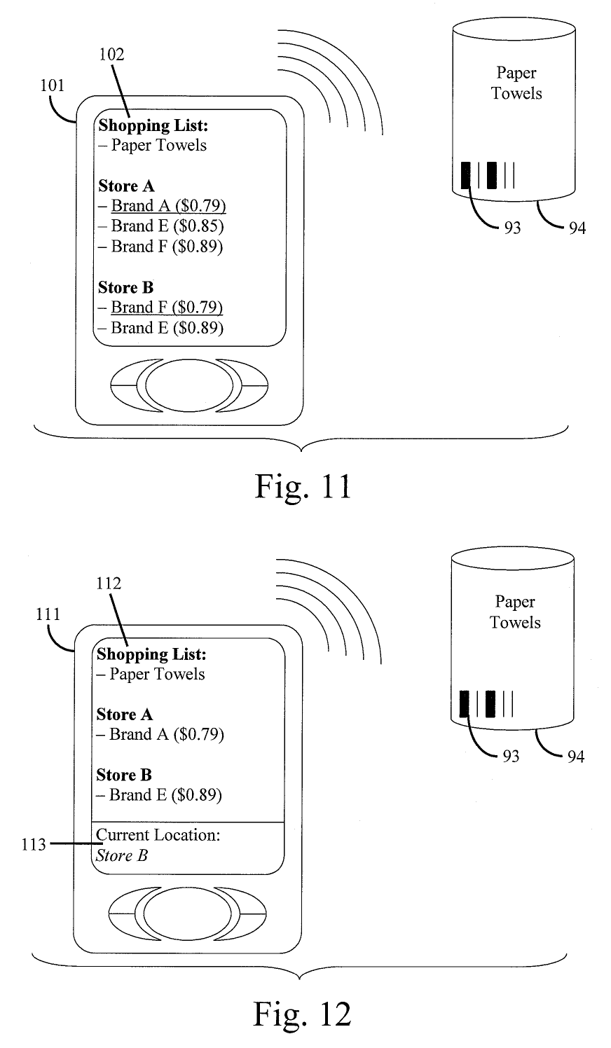

Referring to FIG. 11, another exemplary embodiment of a portable electronic device 101 incorporating aspects of the invention is shown. The device 101 displays a dynamic shopping list 102 to assist a user in comparing product prices among a plurality of merchants. In the device 101 of FIG. 11, the user has enabled the view multiple prices option. The view multiple prices option enables a user to view multiple prices for different brands of a given product instead of only the item corresponding to the lowest priced product per type. For example, the user has added “Paper Towels” to the shopping list 102 by scanning a UPC label 93 on a roll of Paper Towels 94. The shopping list 102 shows that Store A has Brand A Paper Towels for $0.79, Brand E Paper Towels for $0.85 and Brand F Paper Towels for $0.89. The shopping list 102 also shows that Store B has Brand F Paper Towels for $0.79 and Brand E Paper Towels for 0.89. The Store A Brand A Paper Towels and Store B Brand F Paper Towels are both underlined to indicate that they are both the lowest priced product per type (paper towels).

Referring to FIG. 12, another exemplary embodiment of a portable electronic device 111 incorporating aspects of the invention is shown. The device 111 displays a dynamic shopping list 112 to assist a user in comparing product prices among a plurality of merchants. In FIG. 12, the user has specified that paper towels are a priority type of item (e.g. a “must have” item). A priority type of item is an item the user is likely to purchase wherever the user goes shopping, regardless of a lower price elsewhere. After selecting paper towels as a priority type of item, the user has added “Paper Towels” to the shopping list 112 by scanning a UPC label 93 on a roll of Paper Towels 94. Note also that as shown in the current location section 113, the user currently using the device is located in Store B. The shopping list 112 shows that Store A has Brand A Paper Towels on sale for $0.79 while Store B has Brand E Paper Towels on sale for $0.89. However, because the user has selected paper towels as a priority type of item and the user is currently in Store B, the device 111 does not indicate, by underlining, that Store A has the lowest priced item per type for paper towels.

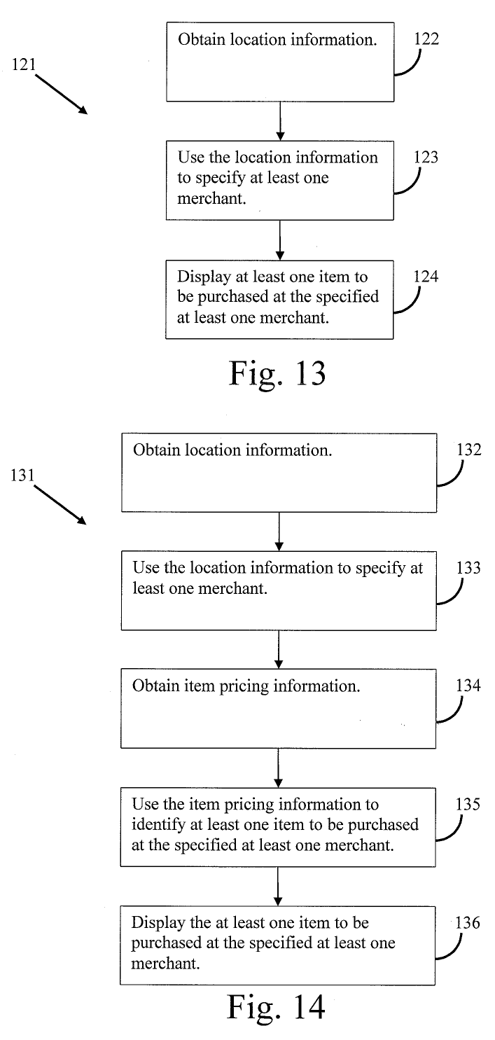

FIG. 13 shows a flowchart illustrating one non-limiting example of a method 121 for practicing the exemplary embodiments of this invention. The method 121 includes the following steps. In box 122, using a portable electronic device, location information is obtained. The location information comprises the current location of the portable electronic device. The location information may be obtained by a user providing the current location (e.g. selecting a location from a list, entering a location, entering location information such as a U.S. zip code), by the device using a global positioning system (GPS) or by the device using any other suitable system that assists the device in determining its current location, as non-limiting examples. The location information may include information expressive of the current store the device is located in or information expressive of the current geographical location of the device, as non-limiting examples. In box 123, the location information is used to specify at least one merchant. In box 124, at least one item to be purchased at the specified at least one merchant is displayed on the portable electronic device.

FIG. 14 depicts a flowchart illustrating another non-limiting example of a method 131 for practicing the exemplary embodiments of the invention. The method 131 includes the following steps. In box 132, using a portable electronic device, location information is obtained. The location information comprises the current location of the portable electronic device. In box 133, the location information is used to specify at least one merchant. In box 134, item pricing information is obtained. The item pricing information comprises a price for at least one item at a plurality of merchants. The item pricing information may be obtained by querying a database, as a non-limiting example. In box 135, the item pricing information is used to identify the at least one item to be purchased at the specified at least one merchant. In box 136, the at least one item to be purchased at the specified at least one merchant is displayed on the portable electronic device.

If a database is queried to obtain the item pricing information, the database may be stored locally or may be stored non-locally. In other embodiments, the portable electronic device includes a transceiver or other communications equipment. The transceiver or other communications equipment can be employed to communicate with a non-locally stored database. As a non-limiting example, the portable electronic device may use a transceiver to access a wireless local area network in order to remotely access a globally-stored database that contains the product pricing information. As an additional non-limiting example, prior to leaving their home for shopping, a user may connect the portable electronic device to the remote database via a home internet connection (e.g. a modem, a cable modem, a digital subscriber line (DSL)). The user may then download current item pricing information to the portable electronic device for subsequent use at the shopping establishment.

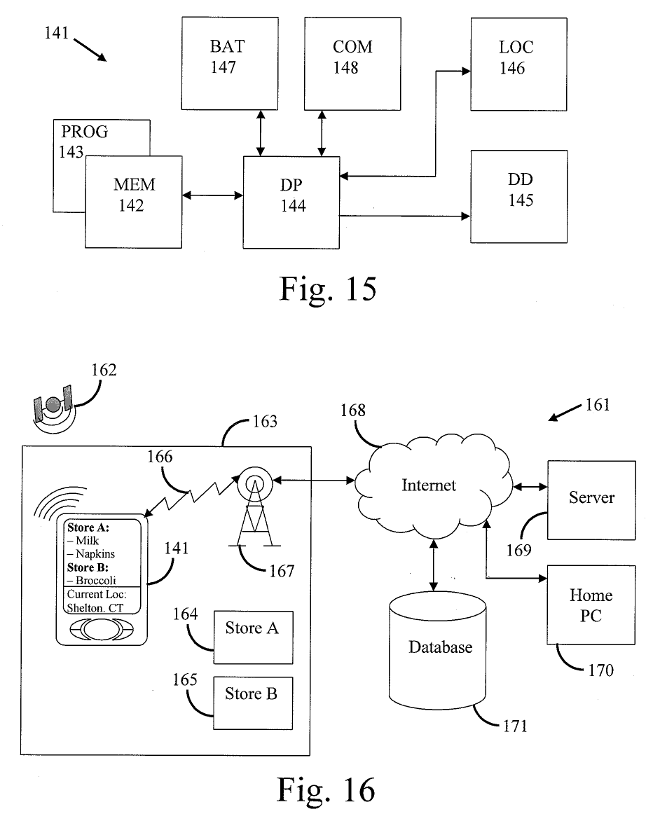

Reference is made to FIG. 15 for illustrating a simplified block diagram of a portable electronic device 141 that is suitable for use in practicing the exemplary embodiments of this invention. In FIG. 15, the electronic device 141 includes at least one memory (MEM) 142 that stores program code (PROG) 143, at least one data processor (DP) 144 coupled to the MEM 142, at least one display device (DD) 145 coupled to the DP 144 and a location determination unit (LOC) 146 coupled to the DP 144. The LOC 146 enables the electronic device 141 to determine its current location. Non-limiting examples of the LOC 146 include a GPS client and any other suitable system that assists the electronic device 141 in determining its current location. The LOC 146 is for assisting the device 141 in obtaining location information to be utilized as explained above. The device 141 may include a battery (BAT) 147 coupled to the DP 144, or, for example, the device could be solar powered. The electronic device 141 may further include a communication interface (COM) 148 coupled to the DP 144. The COM 148 would enable the device 141 to communicate, via a wired or wireless connection, with a foreign agent for the purpose of updating, maintaining, uploading or downloading item pricing information, as discussed above. The COM 148 may comprise any hardware necessary for the device 141 to establish, maintain and/or utilize a wired or wireless connection, such as technology relating to wireless local area networks (WLAN), Bluetooth technology, Wi-Fi technology, radio frequency (RF) communications, optical communications, cellular technology, universal serial bus (USB) connections or FireWire connections, as non-limiting examples. The PROG 143 is assumed to include program instructions that, when executed by the DP 144, enable the portable electronic device 141 to operate in accordance with the exemplary embodiments of this invention, as discussed above in greater detail.

Referring to FIG. 16, a simplified block diagram of one non-limiting example of a communications system 161 within which the portable electronic device 141 of FIG. 15 may operate is shown. In accordance with the exemplary embodiments of the invention, the device 141 uses the LOC 146 in conjunction with a GPS 162 to determine the current location (e.g. the location information) of the device. In the exemplary system 161 of FIG. 16, the device 141 has determined that it is currently located in Shelton, Conn. 163. The device 141 uses the location information to specify at least one merchant. In the exemplary system 161 of FIG. 16, the device 141 has specified Store A 164 and Store B 165. The device 141 uses the COM 148 to form a wireless connection 166 via a local access point 167 for a cellular network (not shown) available in Shelton, Conn. 163. Note that in this exemplary communications system 161, the device 141, both merchants (Store A 164 and Store B 165) and the local access point 167 are all currently located in Shelton, Conn. 163. By utilizing the access point 167 and the cellular network, the device 141 is able to connect to the Internet 168 and further make a connection with one or more sources, such as: a Server 169, a home personal computer (Home PC) 170 or a Database 171, as non-limiting examples. The device 141 downloads item pricing information for from one or more of these sources. The device 141 then uses the item pricing information to identify at least one item to be purchased at the specified merchants and displays the at least one item on the DD 145. As shown on the DD 145 of the device 141 in FIG. 16, a user is to purchase milk and napkins from Store A 164 and broccoli from Store B 165. In the exemplary system of FIG. 16, the rule set employed to match items to the specified merchants is such that the specified merchant has the lowest price for that item type (e.g. lowest price for napkins). Thus, a user is to purchase milk and napkins from Store A 164 because Store A 164 has the lowest price for milk and napkins. In such a manner, utilizing an exemplary embodiment of the invention, the device 141 can assist a user in comparative shopping, within a geographical region, to purchase items based on a given rule set (e.g. lowest price for that item).

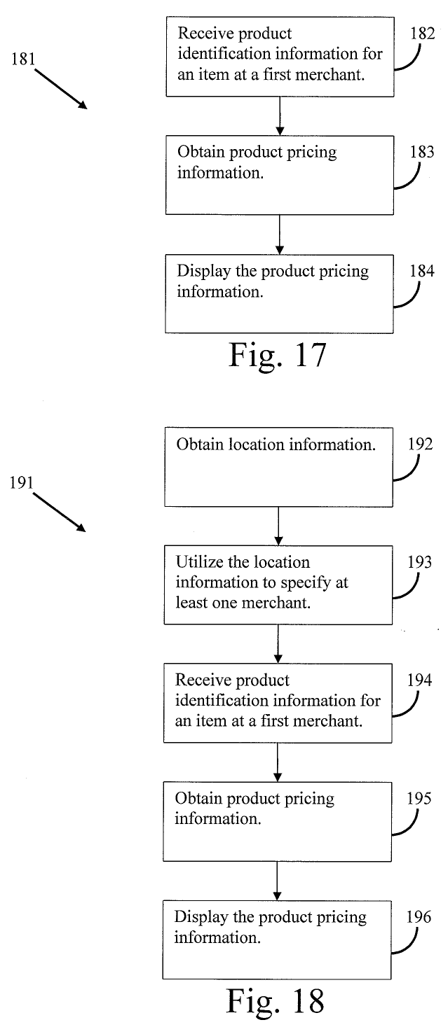

FIG. 17 shows a flowchart illustrating another non-limiting example of a method 181 for practicing the exemplary embodiments of this invention. The method 181 includes the following steps. In box 182, using a portable electronic device, product identification information is received for an item at a first merchant. The product identification information may be received as further explained above. In box 183, utilizing the received product identification information the portable electronic device obtains product pricing information. The product pricing information includes a price for the item at at least one other merchant. The product pricing information may be obtained by querying a database, as a non-limiting example. In box 184, the product pricing information is displayed on the portable electronic device. The product pricing information may be displayed in a shopping list, as a non-limiting example.

FIG. 18 depicts a flowchart illustrating another non-limiting example of a method 191 for practicing the exemplary embodiments of this invention. The method 191 includes the following steps. In box 192, location information is obtained. The location information includes the current location of the portable electronic device. The location information can be obtained by a user providing the current location (e.g. selecting a location from a list, entering a location, entering location information such as a U.S. zip code), by the device using a global positioning system (GPS) or by the device using any other suitable system that assists the device in determining its current location, as non-limiting examples. The location information may include information expressive of the current store the device is located in or information expressive of the current geographical location of the device, as non-limiting examples. In box 193, the location information is utilized to specify at least one merchant for whom product pricing information will be shown on the portable electronic device. In box 194, using the portable electronic device, product identification information is received for an item at a first merchant. The product identification information may be received as further explained above. In box 195, utilizing the received product identification information the portable electronic device obtains product pricing information. The product pricing information includes a price for the item at at least one other merchant. The product pricing information may be obtained by querying a database, as a non-limiting example. In box 196, the product pricing information is displayed on the portable electronic device. The product pricing information may be displayed in a shopping list, as a non-limiting example.

If a database is queried to obtain the product pricing information, the database may be stored locally or may be stored non-locally. In other embodiments, the portable electronic device includes a transceiver or other communications equipment. The transceiver or other communications equipment can be employed to communicate with a non-locally stored database. As a non-limiting example, the portable electronic device may use a transceiver to access a wireless local area network in order to remotely access a globally-stored database that contains the product pricing information. As an additional non-limiting example, prior to leaving their home for shopping, a user may connect the portable electronic device to the remote database via a home internet connection (e.g. a modem, a cable modem, a digital subscriber line (DSL)). The user may then download current product pricing information to the portable electronic device for subsequent use at the shopping establishment.

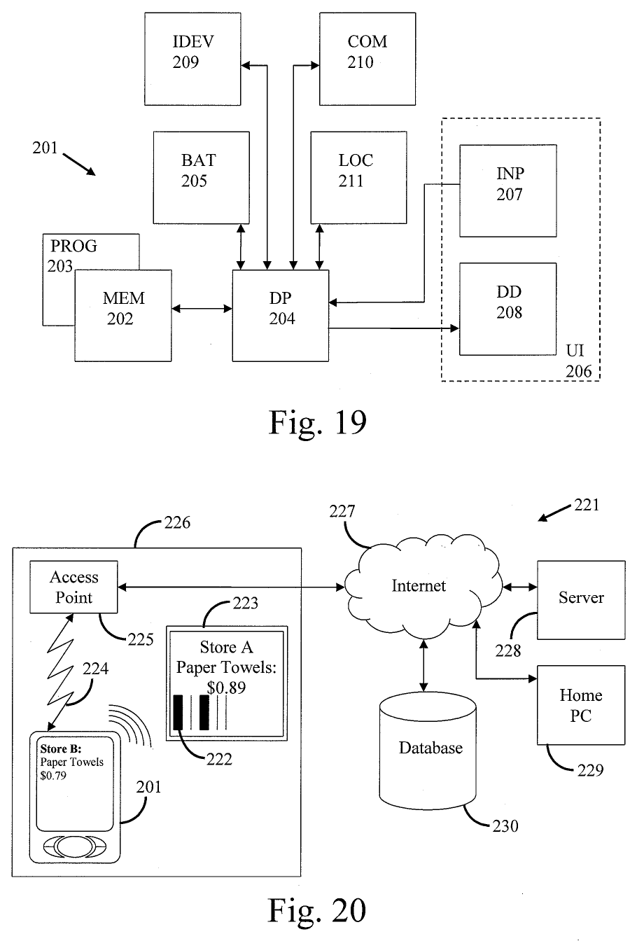

Reference is made to FIG. 19 for illustrating a simplified block diagram of another portable electronic device 201 that is suitable for use in practicing the exemplary embodiments of this invention. In FIG. 19, the electronic device 201 includes at least one memory (MEM) 202 that stores program code (PROG) 203, at least one data processor (DP) 204 coupled to the MEM 202, and a user interface (UI) 206 coupled to the DP 204. A battery (BAT) 205 may be coupled to the DP 204, or, for example, the device could be solar powered. The UI 206 includes at least one user input device (INP) 207 and at least one display device (DD) 208. The electronic device 201 also includes at least one information input device (IDEV) 209 coupled to the DP 204. The IDEV 209 is utilized by the electronic device 201 to receive product identification information. As non-limiting examples, the IDEV 209 may comprise a UPC scanner, a RFID tag reader or an OCR reader. The electronic device 201 further includes a communication interface (COM) 210 coupled to the DP 204. The COM 210 enables the device 201 to communicate, via a wired or wireless connection, with a foreign agent for the purpose of updating, maintaining, uploading or downloading product pricing information, as discussed above. The COM 210 may comprise any hardware necessary for the device 201 to establish, maintain and/or utilize a wired or wireless connection, such as technology relating to wireless local area networks (WLAN), Bluetooth technology, Wi-Fi technology, radio frequency (RF) communications, optical communications, cellular technology, universal serial bus (USB) connections or FireWire connections, as non-limiting examples. The electronic device 201 may optionally include a location determination unit (LOC) 211 coupled to the DP 204. The LOC 211 enables the electronic device 201 to determine its current location. Non-limiting examples of the LOC 211 include a GPS client and any other suitable system that assists the electronic device 201 in determining its current location. The LOC 211 is for assisting the device 201 in obtaining location information to be utilized as explained above. The PROG 203 is assumed to include program instructions that, when executed by the DP 204, enable the electronic device 201 to operate in accordance with the exemplary embodiments of this invention, as discussed above in greater detail.

Referring to FIG. 20, a simplified block diagram of another non-limiting example of a communications system 221 within which the portable electronic device 101 of FIG. 19 may operate is shown. In accordance with the exemplary embodiments of the invention, the device 201 uses the IDEV 209 to receive product identification information by scanning a UPC label 222 on a product sign for paper towels 223. The sign 223 indicates that Store A is selling paper towels for $0.89. The device 201 uses the COM 210 to form a wireless connection 224 via a local access point 225 for a wireless local area network (WLAN) available in the Store A building 226. Note that in this exemplary communications system 221, the sign 223, access point 225 and device 201 are all currently located within the Store A building 226. By utilizing the access point 225, the device 201 is able to connect to the Internet 227 and further make a connection with one or more sources, such as: a Server 228, a home personal computer (Home PC) 229 or a Database 230, as non-limiting examples. The device 201 downloads product pricing information for paper towels from one or more of these sources and displays the product pricing information on the DD 208. As shown in FIG. 20, the product pricing information comprises the price of paper towels at Store B, $0.79. Thus a user of the device is able to obtain product pricing information which the user may utilize to compare the price of paper towels at Store A with the price of paper towels at Store B.

Exemplary embodiments of the invention can take the form of an entirely hardware embodiment, an entirely software embodiment or an embodiment containing both hardware and software elements. In a typical embodiment, the invention is implemented in software, which includes but is not limited to firmware, resident software and/or microcode, as non-limiting examples.

Furthermore, exemplary embodiments of the invention can take the form of a computer program product accessible from a computer-useable or computer-readable medium providing program code for use by or in connection with a computer or any instruction execution system. For the purposes of this description, a computer-useable or computer-readable medium can be any apparatus that can contain, store, communicate, propagate, or transport the program for use by or in connection with the instruction execution system, apparatus, or device.

The medium can be electronic, magnetic, optical, electromagnetic, infrared, a semiconductor system (or apparatus or device) or a propagation medium, as non-limiting examples. Non-limiting examples of a computer-readable medium include a semiconductor or solid state memory, magnetic tape, a removable computer diskette, a random access memory (RAM), a read-only memory (ROM), a rigid magnetic disk and an optical disk. Current, non-limiting examples of optical disks include compact disk-read only memory (CR-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or indirectly through intervening I/O controllers.

Network adapters may also be coupled to the system to enable the data processing system to become coupled to other data processing systems or remote printers or storage devices through intervening private or public networks. Modems, cable modem and Ethernet cards are just a few non-limiting examples of the currently available types of network adapters.

Although illustrated above with regards to paper towels and various brands of paper towels, the invention is applicable to other types of goods, items and products, including grocery products, clothing products and office supplies, as non-limiting examples. Furthermore, although shown above with only one item, it is understood that the shopping list of the invention may contain more than one item.

The invention provides a system and method for maintaining a dynamic shopping list which may be employed to leverage location-based services to modify the list based on the location of the user, the price of the items listed and shopping preferences of the user.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A computer program product comprising program instructions embodied on a tangible computer-readable medium, execution of the program instructions resulting in operations comprising:
using a portable electronic device, obtaining location information, wherein the location information comprises the current location of the portable electronic device;
utilizing the obtained location information to specify at least one merchant; and
displaying on the portable electronic device at least one item to be purchased at the specified at least one merchant.

2. The computer program product of claim 1, execution of the program instructions resulting in operations comprising additional intermediate steps of:
obtaining item pricing information comprising a price for the at least one item at a plurality of merchants; and
utilizing the item pricing information to identify the at least one item to be purchased at the specified at least one merchant.

3. The computer program product of claim 2, wherein the item pricing information is utilized such that the specified at least one merchant has a lowest price for the at least one item to be purchased at the specified at least one merchant.

4. The computer program product of claim 2, wherein the item pricing information is utilized such that the specified at least one merchant has a lowest priced product per type for the at least one item to be purchased at the specified at least one merchant.

5. The computer program product of claim 2, wherein the item pricing information is utilized such that the specified at least one merchant has a lowest brand price for the at least one item to be purchased at the specified at least one merchant.

6. The computer program product of claim 1, wherein the location information is obtained using a global positioning system (GPS).

7. The computer program product of claim 1, wherein the location information is obtained by a user manually entering information on the portable electronic device.

8. The computer program product of claim 1, execution of the program instructions resulting in operations further comprising: enabling a user to select at least one merchant from the specified at least one merchant.

9. The computer program product of claim 1, execution of the program instructions resulting in operations further comprising: providing a user with an option to specify a priority type of item.

10. The computer program product of claim 1, execution of the program instructions resulting in operations further comprising: providing a user with an option to display the item pricing information on the portable electronic device.

11. The computer program product of claim 1, execution of the program instructions resulting in operations further comprising an initial step of: using the portable electronic device, receiving product identification information for the at least one item, wherein the received product identification information is considered when specifying the at least one merchant.

12. The computer program product of claim 11, wherein the received product identification information comprises an item type of the at least one item and wherein the item type is considered when specifying the at least one merchant.

13. The computer program product of claim 11, wherein the portable electronic device receives the product identification information by reading a machine-readable label.

14. The computer program product of claim 11, wherein the portable electronic device receives the product identification information by a user manually entering information on the portable electronic device.

15. A method comprising:
using a portable electronic device, obtaining location information, wherein the location information comprises the current location of the portable electronic device;
utilizing the obtained location information to specify at least one merchant; and
displaying on the portable electronic device at least one item to be purchased at the specified at least one merchant.

16. The method of claim 15, further comprising:
obtaining item pricing information comprising a price for the at least one item at a plurality of merchants; and
utilizing the item pricing information to identify the at least one item to be purchased at the specified at least one merchant.

17. The method of claim 15, further comprising: receiving product identification information for the at least one item, wherein the received product identification information is considered when specifying the at least one merchant.

18. A portable electronic device comprising:
at least one memory;
at least one data processor coupled to the at least one memory;
at least one display device coupled to the at least one data processor; and
a location determination unit coupled to the at least one data processor, wherein the at least one data processor is operable to perform operations comprising:
obtaining location information using the location determination unit, wherein the obtained location information comprises the current location of the portable electronic device;
utilizing the obtained location information to specify at least one merchant; and
displaying on the at least one display device at least one item to be purchased at the specified at least one merchant.

19. The portable electronic device of claim 18, further comprising: at least one communications interface coupled to the at least one data processor, wherein the at least one data processor is operable to perform operations further comprising:
obtaining item pricing information using the at least one communications interface, wherein the item pricing information comprises a price for the at least one item at a plurality of merchants; and
utilizing the item pricing information to identify the at least one item to be purchased at the specified at least one merchant.

20. The portable electronic device of claim 18, further comprising: at least one information input device coupled to the at least one data processor, wherein the at least one data processor is operable to perform operations further comprising: receiving via the at least one information input device product identification information for the at least one item, wherein the received product identification information is considered when specifying the at least one merchant.
